(19) United States
(12) Patent Application Publication
(10) Pub. No.: US 2006/0079129 A1
(43) Pub. Date: Apr. 13, 2006

(54) Combination of light base and connector

(76) Inventor: Shiu-Min Hsu, Chang Hua Shien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/179,572

(22) Filed: Jul. 13, 2005

(30) Foreign Application Priority Data
Oct. 10, 2004 (TW) 093216166

(51) Int. Cl. H01R 13/40

(52) U.S. Cl. 439/602

(57) ABSTRACT

A light base having a first positive contact point and a first negative contact point on an inside of a rectangular recess defined in the base, and a connector which has a rectangular insertion for being inserted in the recess and includes a second positive contact point and a second negative contact point, A stop extends from an inside of the recess and the connector includes an engaging member so that when the insertion is engaged with the rectangular recess, the stop is engaged with the engaging member. The first positive contact point and the first negative contact point are in contact with the second positive contact point and the second negative contact point so as to form a circuit connection. The connector is able to sort and connect different number of wires of different light bases.

### FIELD OF THE INVENTION

The present invention relates to a combination of light base and connector which is easily engaged with the base and adapts different light assemblies with different specifications.

### BACKGROUND OF THE INVENTION

For head light assembly of vehicles, customers have many choices among halogen bulbs, quartz bulbs, HID, or LED, and different requirements of the wires are needed to cooperate with the specific light assemblies. Conventional light assemblies for vehicles are vary according to different area and brands. Most of the light assemblies include a light base with a light bulb connected thereto and a tubular connector which is inserted into a receptacle with a frame having a recess that is complimentary to the shape of the tubular connector. However, some light base is rectangular so that an adapter is needed and connected between the rectangular base and the conventional frame. Furthermore, different brands of connectors have individual arrangements of contact points so that the adapters are required to sort the wires and to connect the electrical poles.

The present invention intends to provide a combination of light base and connector which is easily inserted into the base and sorts and connects wires of the base.

### SUMMARY OF THE INVENTION

The present invention relates to a light base which has a rectangular recess and a stop extends from an inside of the recess. A first positive contact point and a first negative contact point are connected to the inside of the recess. A connector includes a rectangular insertion which is engaged with the rectangular recess and has a second positive contact point and a second negative contact point so as to be in contact with the first positive contact point and the first negative contact point. An engaging member is connected to the outside of the insertion so as to be engaged with the stop when the insertion is inserted into the recess of the base.

The primary object of the present invention is to provide a connector which is easily and securely connected with a light base, and the connector is able to sort and connect with different numbers of wires of the light base.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a cross sectional view of the connector of the present invention;

FIG. 2 is an exploded view to show the light base and the connector of the present invention;

FIG. 3 is a cross sectional view of the connection of the light base and the connector of the present invention;

FIG. 4 shows another embodiment of the light base and the connector of the present invention;

FIG. 5 shows yet another embodiment of the light base and the connector of the present invention, and

FIG. 6 shows a cross sectional view of the connection of the light base and the connector in FIG. 5.

### DETAILED DESCRIPTION OF THE PREFERRED EMBODIMENT

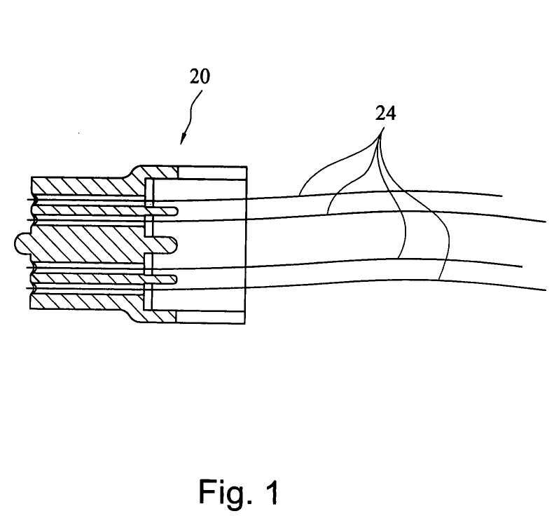

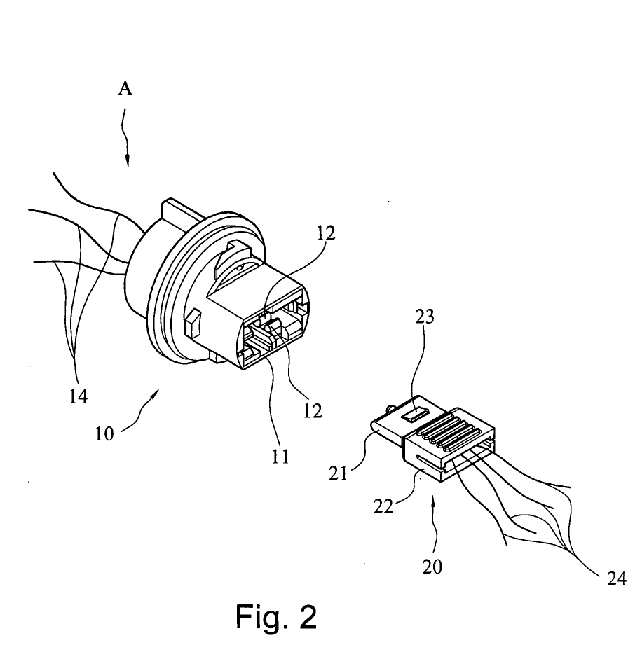

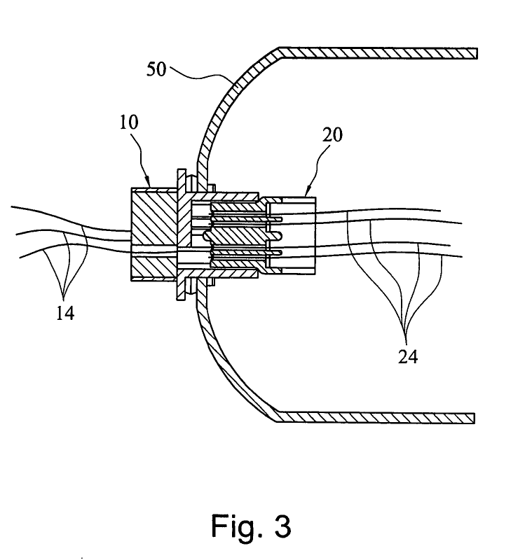

Referring to FIGS. 1 to 3, a light assembly “A” includes a light base 10 and a connector 20, wherein the light base 10 has a rectangular recess 11 defined in an end thereof and two stops 12 extends from two facing insides of the recess 11. A first positive contact point and a first negative contact point are connected to the inside of the recess 11. Three first wires 14 extend from the light base 10.

The connector 20 includes a rectangular insertion 21 and a handle portion 22 which is connected to the insertion 21 and includes a slot defined in a distal end thereof so that the handle portion 22 can be squeezed to be thinner for convenience of insertion in the recess 11 of the base 10. The insertion 21 has a second positive contact point and a second negative contact point connected to an outside of the insertion 21 so that when the insertion 21 is engaged with the recess 11 of the base 10, the first positive contact point and the first negative contact point are in contact with the second positive contact point and the second negative contact point so as to form a circuit connection. Two engaging members 23 (only one is shown) are connected to the outside of the insertion 21 and are engaged with the stops 12. The engaging members 23 each are a protrusion with an inclined surface so that when the insertion 21 is inserted in the recess 11, the stops 12 move over the inclined surfaces and are engaged with the engaging members 23 to generate a sound of “click” to inform the users that the base 10 and the insertion 21 are connected with each other. There are four second wires 24 connected to the connector 20 and having two positive and two negative connection ends as shown in FIG. 1, one of the first wires 14 is connected to two of the second wires 24 so that the base 10 with three first wires 14 is connected to the connector 20 with four second wires 24.

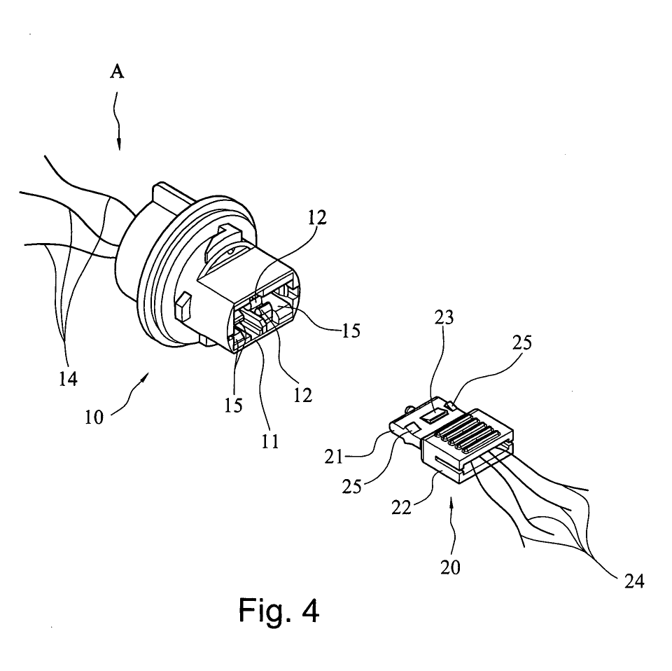

As shown in FIG. 4 which shows another embodiment which includes two second stops 15 extending from the inside of the facing insides in the recess 11 and the insertion 21 includes two second engaging members 25 which are able to be engaged with the second stops 15 to further secure the connection of the base 10 and the connector 20.

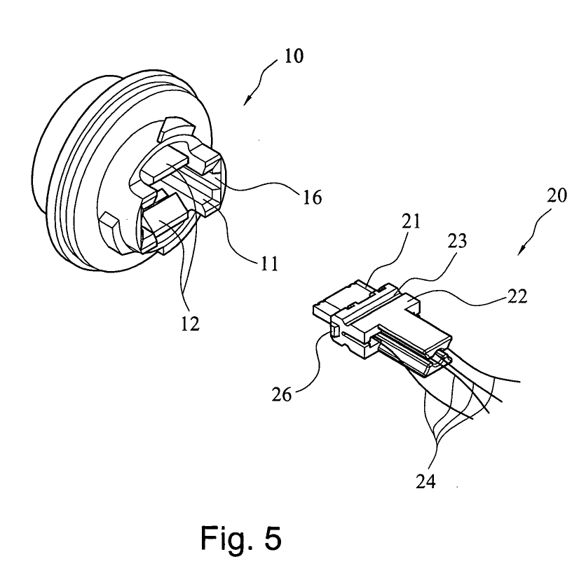

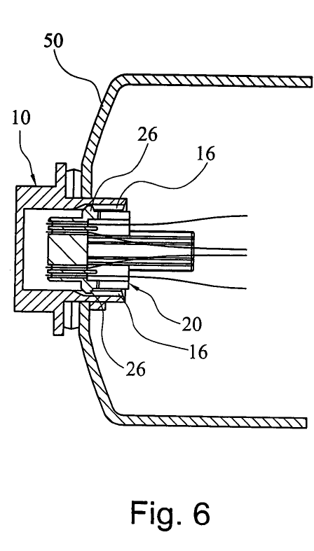

FIGS. 5 and 6 show yet another embodiment wherein a bulb 50 is mounted to the light base 10 and the engaging members 23 are two grooves defined in two opposite sides of the handle portion 22 of the connector 20 so that the stops 12 are engaged with the grooves. In addition, two receiving grooves 16 are defined in two insides of the recess 11 and the handle portion 22 includes two bosses 26 extending from two sides thereof, the bosses 26 slidably engaged with the two receiving grooves 16.

The connection between the light base 10 and the connector 20 is more secure by the stops 12 and the engaging members 23. The handle portion 22 can be squeezed to be thinner so as to be easily inserted in the recess 11 and after released, the two parts separated by the slit bounce back to securely engage the stops 12 and the engaging members 23. The second stops 15, the second engaging members 25, the bosses 26 and the receiving grooves 16 make the connection more secure. The first wires 14 and the second wires 24 are connected properly by the insertion of the connector 20 so that the assemblers need not to connect the wires 14, 24 one by one.

While we have shown and described the embodiment in accordance with the present invention, it should be clear to those skilled in the art that further embodiments may be made without departing from the scope of the present invention.

What is claimed is:

1. A combination of a light base and a connector, wherein the light base has a rectangular recess and a stop extends from an inside of the recess, the connector includes a rectangular insertion which is engaged with the rectangular recess, an engaging member is connected to the outside of the insertion and engaged with the stop.

2. The combination as claimed in claim 1, wherein the engaging member is a protrusion with an inclined surface.

3. The combination as claimed in claim 1, wherein the engaging member is a groove.

4. The combination as claimed in claim 1, wherein the connector includes a handle portion which is connected to the insertion and includes a slot defined in a distal end thereof.

5. The combination as claimed in claim 4, wherein the engaging member is a groove which is defined in the handle portion.

6. The combination as claimed in claim 4, wherein two receiving grooves are defined in two insides of the recess and the handle portion includes two bosses extending from two sides thereof, the bosses slidably engaged with the two receiving grooves.
